(19) United States
(12) Patent Application Publication
(10) Pub. No.: US 2008/0233271 A1
(43) Pub. Date: Sep. 25, 2008

(54) Layered Structures And Method For Producing The Same

(76) Inventor: Thomas Haring, Stuttgart (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 11/937,306

(22) Filed: Nov. 8, 2007

Related U.S. Application Data
(63) Continuation of application No. 10/929,200, filed on Aug. 30, 2004, now abandoned.
Application No. 10/929,200 is a continuation of application No. PCT/DE03/00734, filed on Feb. 28, 2003.

(30) Foreign Application Priority Data
Feb. 28, 2002 (DE) 102 08 679.6
Dec. 23, 2002 (DE) 102 61 794.5

(51) Int. Cl. B05D 5/12

(52) U.S. Cl. 427/58

(57) ABSTRACT

A method for producing membranes and membrane electrode units by laying thin film layers on a porous carrier substrate. The layers are applied using only one of several production methods, but have different functional properties. These membranes and membrane electrode units may be used to generate energy by electrochemical or photochemical processes, particularly applicable in fuel cells.

This application is a continuation of U.S. application Ser. No. 10/929,200, filed Aug. 30, 2004, which is a continuation of PCT/DE03/00734, filed Feb. 28, 2003.

### FIELD OF THE INVENTION

The invention concerns methods for the production of membranes. Furthermore the invention concerns methods for the production of membrane electrode units.

### BACKGROUND OF THE INVENTION

The production of polymer electrolyte membrane fuel cells (PEM) typically starts out from a central membrane which is connected with a catalytic layer on both sides. Electron conducting materials such as carbon cloths or similar are deposited on the layers. A polymer electrolyte membrane fuel cell has a layer construction in which every layer has to accomplish its specific tasks. These tasks are in partial opposition to one another. The membrane must have very high ion conductivity, but should have no or only very low electron conductivity and be gastight completely. In contrast, the gas diffusion layer must have very high gas permeability and great electron conductivity. Since the different tasks for each layer can only be fulfilled by different materials, the problem of the incompatibility of these materials arises often. Looking at a cross-cut view, hydrophobic and hydrophilic layers exist within micrometers of one another. Creating a thin compound with the materials is a prevalent problem in technology and leads to a non-optimal efficiency. The membranes must have a certain minimum thickness or else they can't be processed technically. So a membrane having a thickness of only a few microns can only very difficultly be hot-pressed with a powder containing catalyst without being destroyed. The task therefore is to provide methods for the production of layer structures and methods which ensure an improved connection of the layers between each other. The invention provides material and material combinations which only now make the production of these layer structures possible.

### SUMMARY OF THE INVENTION

The membranes and membrane electrode units according to the invention can be used for the generation of energy by an electrochemical or photochemical process, particularly for membrane hydrogen fuel cells (H2 or direct methanol hydrogen fuel cells) at temperatures of −20 to +180° C. Work temperatures up to 250° C. are possible in an embodiment. The membranes and membrane electrode units according to the invention can be used in a variety of membrane processes. They are particularly applicable in galvanic cells, secondary batteries, electrolysis cells, membrane separation processes like gas separation, pervaporation, perstraction, reverse osmosis, electric dialysis, and diffusion dialysis and in the separation of alkene-alkane mixtures or in the separation of mixtures in which a component forms complexes with silver ions.

The invention provides methods for the production of layer structures and methods which ensure an improved connection between the layers. This task is solved by two parts of the invention. In the first part, the construction of the layer structure takes place not starting from a membrane and producing layers from inside to the outside, but instead starting from the outside (cathode or anode) to the inside (membrane) and then back to the outside (anode or cathode). The second aspect of the invention is the use of carrier substrates to support the membrane electrode units.

### BRIEF DESCRIPTION OF THE DRAWINGS

FIG. 1A displays the typical cross section of a polymer electrolyte fuel cell (PEM).

FIG. 1B displays an enlarged view of the catalyst layer of a PEM.

FIG. 1C displays an enlarged view of the catalyst layer of a PEM, which identifies the individual particles and details the catalyst particles carried on support particles.

FIG. 1D displays an enlarged view of the catalyst layer of a PEM, identifying the various particles within the layer.

FIG. 2 illustrates the by-layer construction method.

FIG. 3 displays the stack wise construction of several units in bipolar style, exemplary with four units.

FIG. 4 displays the flat serial connection in side view, exemplary with four units.

FIG. 5 is a schematic of the flat serial connection in top view, exemplary with four units.

FIG. 6 is a schematic of a flat serial connection with additional external connection, in side view.

FIG. 7 is a schematic of the simultaneous serial and parallel connection on a substrate, exemplary with eight units.

FIG. 8A is a schematic of the connection for single cells, whereby the porous substrate has a cylindrical form.

FIG. 8B is a schematic of the connection of single cells, whereby the porous substrate has a cylindrical form and the fuel e.g. hydrogen or methanol is supplied by the cylinder.

FIG. 8C is a schematic connection of single cells, whereby the porous substratum has a cylindrical form and the oxygen or the air is supplied by the cylinder.

FIG. 9 illustrates the chemical interactions that bond the membrane polymer to ionomers in the catalyst layer.

### DETAILED DESCRIPTION OF THE INVENTION

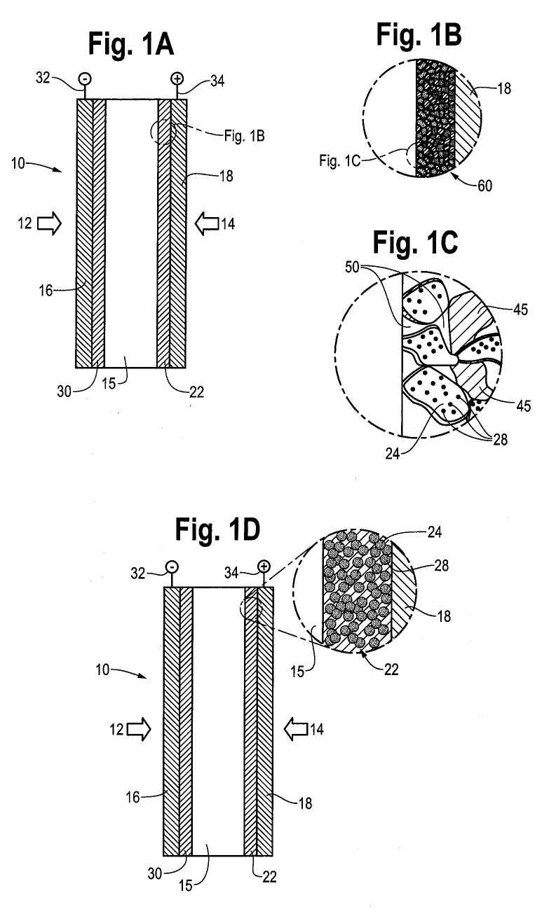

FIGS. 1A, 1B and 1C show the cross-section of a fuel cell with an electrode structure as it can be made with the classic process, coating a membrane 15 with inks containing catalyst 30, or produced with a printing process. FIG. 1A shows the fuel cell unit 10 containing gas or liquid reactants, i.e. the supply of a fuel 12 and the supply of an oxidant 14. The reactants diffuse through porous gas diffusion layers 16 and 18 and reach the porous electrodes which form the anode 30 and cathode 22 and at which the electrochemical reactions take place. The anode 30 is separated by an ion conducting polymer membrane 15 from the cathode 22. The anode's supply 32 and the cathode's supply 34 are necessary for the connection to an external circuit or for the connection to further fuel cell units. FIG. 1B is an enlarged view of the cathode 22 of the porous gas diffusion electrode 60 which is supported on a gas diffusion layer 18 and is in connection with the electrolytic polymer membrane 15. The reactants diffuse through the diffusion structure 18, are distributed evenly, and then react in the porous electrode 60. FIGS. 1C and 1D show another magnification of the electrode. Catalytically active particles 28, either non-supported catalysts 25 or carbon supported catalysts 24 (metal particles which are distributed on the support) determine the porous structure. Additional hydrophilic or hydrophobic particles 45 can be present to change the wettability with water of the electrode or to determine the pore size. In addition to this, ionomer portions 50 are inserted in the electrode by impregnation or by other methods to fulfill the different functions of an efficient electrode: the ionic conductivity of the electrode is increased, and the reaction zone of the catalytically active particles 25 and 28 is extended. The electronic conductivity is decreased by inserting ionomer portions 50, particularly perfluorinated sulfonic acids. At an empirical optimization of the content, however, a compromise which maximizes the reaction zone can be found between an electronic and ionic conductivity. Furthermore, the ionomer portions 50 serve to improve the adhesion of the electrode 22 and 30 to the membrane 15. This applies particularly to chemically similar materials. The improved adhesion is caused by the adhesion favorable flow behavior of the fluorinated polymers.

When using new and economical polymer membranes, such as acid-base blends based on arylpolymers, the herewith described electrode concept leads to the formation of poorly adherent layers. The electrode structure and particularly the boundary surface to the membrane can be improved by the invention. Instead of an ionomer in the protonated form it is preferential to bring one or more ionomer in a preliminary form into a dispersion or in solution. The electrolyte membrane or the diffusion layer is coated with this dispersion and/or solution as electrode ink by means of suitable methods. A further embodiment consists of combining the several precursor ionomers and inorganic particles to improve the wettability and the water retention in the electrode. By a specific post treatment, e.g., by hydrolysis or by a tempering step, the properties of the electrode are improved. The electrode produced in this manner advantageously fulfills the functions necessary for the application. By using ionomers coordinated with each other and by post treating, ionic and/or covalent networking of the ionomers takes place in the electrode. This leads to an extensive ionic and/or covalent network in the electrode layer. An electrode produced in this manner has advantageous properties both regarding the extension of the reaction zone and also regarding the adhesion to the membrane. This applies particularly to membranes that do not consist of perfluorierten hydrocarbons. The use of electrolyte material out of several components in addition permits a layerwise construction of the catalyst layer, whereby selective structure and properties of the catalyst layer can be obtained, e.g. by a layerwise construction or by use of methods which are suitable for multicolor print.

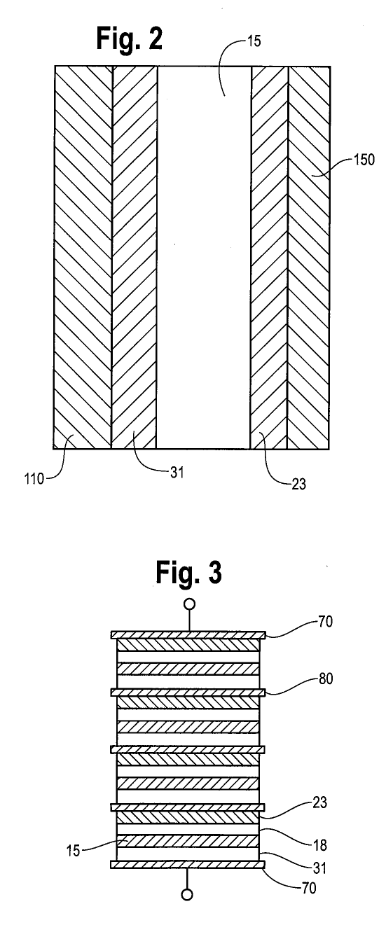

In the invention, a polymer electrolyte membrane fuel cell 10 is schematically built from left (anode) to the right (cathode) from a porous layer 110 which, if necessary, also has a supporting function and often has a low electrical resistance sometimes followed by other porous layers 31, often non-woven materials, with low electrical resistance and these sometimes contain depending on application and manufacturer, catalytically active substances. A more or less thick electrolyte layer 15, e.g., a polymer membrane which is ion conducting and is often coated with catalytically active substances, then follows this layer. As shown in FIG. 2, the cathode side of the membrane includes a catalytic layer 23 followed by porous structures 150.

FIG. 2 displays the method according to invention, which is characterized by a porous basic structure or a porous substratum 110 on which one or more thin layers 31 or coats are applied, which in a particular embodiment contain catalytically active substances. On this layer the selective separating layer 15 follows, and if necessary again thin layers 23 and finally a porous substratum 150 get applied.

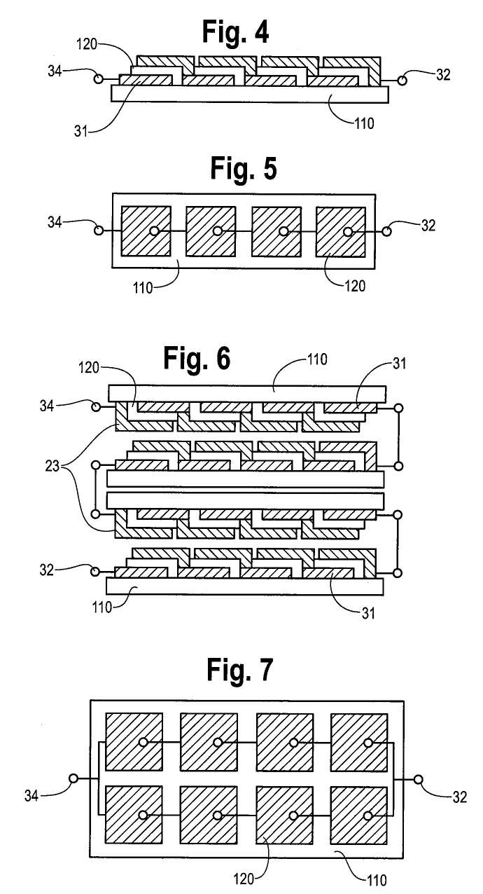

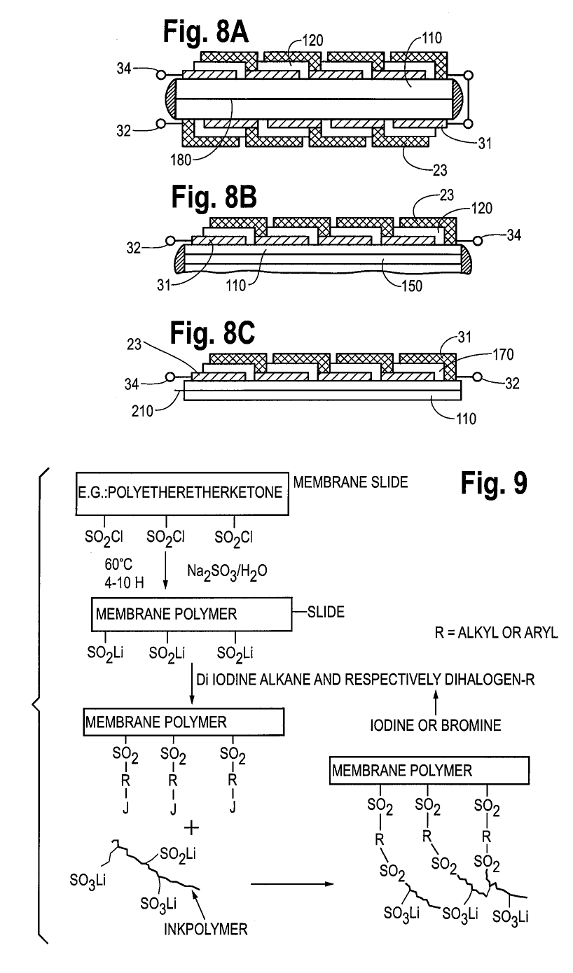

The invention makes possible the production of units characterized by layer construction as displayed in FIGS. 4-7. Starting out from a porous substrate 110, the layers are built in a particular embodiment one after each other starting with a porous electrode layer 34, followed by a mostly dense ion conducting electrolyte layer 120, which in turn is covered by a porous electrode layer 32. The individual layers are established out of dispersions or solutions with special functional properties. One of several production techniques may be used, including spray, roll, print (e.g., silk-screen print, relief printing, gravure printing, pad printing, ink-jet pressure, stencil printing), knife-coated process, CVD, lithographical, laminating, decal picture process and plasma methods. A special embodiment represents the production of gradient layers with fluent transitions of, in particular, the functional properties.

In this embodiment, a unit is used as a fuel cell, in particular as a polymer electrolyte membrane fuel cell. The construction of one electrode to the other layer by layer by the employed methods makes very thin layers possible. The individual units can be miniaturized and arranged beside each other on the same substratum. The preferred substratum is a flat construct and can as such have different properties over the area again. The units formed by the layer construction can be, in the case of the galvanic unit, connected in serial or in parallel. The connection happens during the production process. It is also possible with the presented methods to connect the electrodes through the membrane. The created fuel cell elements can be connected both horizontally and vertically. The created units can differ in size. Great units and small units are produced on the same substrate surface besides each other. This can be used to connect specific single cells together to create a desired voltage.

An essential advantage of the invention consists in the complete production of the layer structures, particularly that galvanic cells can be carried out in a special method in one single production sheet with only one production method. The production is therefore substantially simpler, timesaving and economical.

Further advantages arise by the fact that the elements can be built up modularly and that, by connection of single elements, any level of power can be obtained. The production of fuel cell units with higher voltage or higher current densities is substantially simplified by the manufacturing method according to the invention, because the serial or parallel single cells can be connected directly in a level during production. The performance of the galvanic cell can be adapted to the respective application in a simple way.

By connecting the single cells over the area there is no more need for a complex regulation. Due to these methods it is possible to connect fuel cells over an area such that on the area of a DIN A4 sheet (21×29.5 cm) (plus/minus 10%) the output voltage could range from 5 to 600 volts. Preferred embodiments would output 12-240 volts, and particularly preferred embodiments would output the range of 10 to 15 volts, the range of 110 to 130 volts and the range of 220 to 240 volts of direct current. No electronics are used. A limiter circuit with an inverter may still be necessary for consumer applications. The areas, for example in the size of a DIN A4 sheet, can be arranged again themselves as a stack. This construction has the advantage that, should an area fail on a side, the complete stack will not fail. The performance of the stack decreases by the failed area, but the voltage remains constant without regulation effort. In this case, a simple repair will fix the system.

Another advantage of the invention is the production of gradient layers. The functional properties can be adapted better and coordinated with each other thereby.

The carrier-substrate-concept has the advantage that the active layers don't have to perform any mechanically load-bearing function. The mechanical and functional chemical or electronic properties can be decoupled by each other. Thus a variety of further functional materials are available which otherwise could not be used because of inadequate mechanical properties. Both the layer-by-layer construction of the galvanic cells and the carrier-substrate-concept open up the possibility of a considerable material and weight saving.

The invention permits the production of galvanic cells with flexible design and considerable room saving.

The functional properties of the layers can be adapted by adding suitable substances in the dispersions or solutions. These substances may include pore builders to increase the porosity, hydrophobic or hydrophilic additives for the variation of the wetting behavior (e.g., teflon and/or sulfonated and/or nitrogen containing polymers), substances to increase the electrical conductivity, in particular soot, graphite and or electrically conducting polymers like polyaniline and/or polythiophene and derivatives thereof or additives for increasing the ionic conductivity (e.g., sulfonated polymers). In addition, supported or unsupported catalysts, particularly metals containing platinum, can be added. Soot and graphite are preferred particularly as carrier substances 24. A further embodiment contains the addition of a combination of different polymers both to the carrier substrate and to the solutions and/or dispersions which are used for the construction of the layers applied on the carrier substrate.

These can be taken from German application DE 10208679.6 (unpublished at the time of filing the present application). It is about new polymeric materials, methods to the production and there already partly revealed cross-linking methods of membrane polymers of the polymers, polymer building blocks, main chains and functional groups, which is here referred to in particular. The materials described in application DE 10208679.6 are usable both for inks and for membranes.

Preferred in particular are polymers with the functional groups, which are listed in the application DE 10208679.6 with the abbreviation (2A) to (2R), (3A) to (3J) and the rest Ri as defined therein, and the crosslinking bridges (4A) to (4C) as listed.

In the following examples, compositions for dispersions and production conditions concerning the production of fuel cell units are listed.

### PREFERRED EMBODIMENTS

Example of Dispersions for the Electrodes:

Cathode: 70 weight % Johnson Matthey Pt Black; 9 weight % Nafion EW 1100 solution (Dupont) conveyed in aqueous form; 21 weight % PTFE; coverage: 6.0 mg/cm².

Anode: 80 weight % Johnson Matthey PtRu Black; Pt 50%, Ru 50% (atom weight %); 20 weight % Nafion EW 1100 solution (Dupont) conveyed in aqueous form coverage: 5.0 mg/cm².

Dispersion for the Electrolyte:

Nafion EW 1100 solution (Dupont) may be conveyed in aqueous or in cation exchanged form with an addition of 120% to 160% aprotic solvent, such as DMSO, NMP and DMAc, in which DMSO is preferred.

Alternatively for Nafion® all soluble or dispersible functionalized polymers as described before can be used, which at least after one or several post treatments have a proton releasing functional group, which have an IEC superior to 0.7 meq/g (related to the polymer mass), particularly preferred are polyaryl materials, which are soluble in aprotic and protic solvents, such as DMSO, NMP, THF, water and DMAc, in which DMSO is preferred again.

A variant on the production of electrode electrolyte units is the spraying method (Airbrush). The cathodes or anode layer is applied in the process on the carrier substrate first. The respective dispersion occurs after the above formula is sprayed on the carrier substrate. The carrier substrate has a temperature of 20 to 180° C., preferably 110° C. Then the electrode substrate unit is tempered at a temperature of 130° C. to 160° C. for at least 20 minutes. The electrolyte is also applied with the spraying method. When using Nafion-DMSO dispersion as the electrolyte starting substance, warming the unit to approx. 140° C. is advisable. The drying of the electrolyte layer can be accelerated with a hot air beam. Next, the unit is post treatment in a vacuum drying cabinet, at between 130° C. and 190° C., for 10 minutes to 5 hours depending on the electrolyte dispersion used. After cooling to room temperature the unit is reprotonated at 30 to 100° C. for 30 minutes to 3 hours, preferably 1.5 hours in 0.3M to 3M H₂S0₄, that is conveyed to the acid form. The unit is then cleaned thoroughly for 30 minutes to 5 hours at about 20° C. to 150° C. in Millipore H₂0. In turn the corresponding second electrode is on sprayed on the electrolyte film at about 20 to 180° C. and tempered at 130° C. to 160° C. for at least 20 minutes.

The graphite paper TOP-H 120 of the company Toray can be used as carrier substrate for single cells, for example. It is preferential if the paper is teflonated (approx. 15% to 30% PTFE content). In arrangements with leveled serial connection of several cells (e.g., FIGS. 4-7), electrically non-conductive substrates are used. Possible materials are stretched filled foils, porous ceramics, membranes, filters, felts, fabrics, and fleeces particularly out of temperature resistant synthetic materials and with low surface roughnesses. In a particular embodiment foils containing phyllosilicates and/or tectosilicates are used as porous materials.

A special advantage of the invention is that galvanic cells with a simple construction can be operated at simple operating conditions, particularly environmental conditions, without losses of pressure. FIG. 4 depicts an embodiment of the carrier substrate fuel cell unit. The cathodes 34 are disposed on the carrier substrate 110. An electrolyte layer 120 is disposed on top of the cathodes 34 and anodes 32 are disposed on top of the electrolyte layer 120. Such a fuel cell unit can be operated in a simple way without additional components at ambient pressure and ambient temperature if the unit is installed such into a case wherein a fuel room is located directly above the anode and the cathode provides itself with breathing air through the carrier substrate. Hydrogen, methanol or ethanol can be used as fuel, for example.

In an embodiment the flat connected cells are wrapped such as into FIGS. 4, 5 or 7. It has to be paid attention that the porous structure is completely is tight on its underside.

The carrier substrate should preferably fulfill the following requirements: an open porosity which permits the passage of a gas or a fuel to a necessary minimum for the application. The porosity should be in the range of 20 to 80% by volume, particularly preferred is 50 to 75%. The fuel supply or also the gas supply can be adjusted by the porosity of the substrate. A cylindrical arrangement of the porous substrate with a central supply channel possessing a porosity below 60 Vol % also suffices. Depending upon the cell construction, the porous structure can have electronic conductivity or no electronic conductivity, surface as smooth as possible, or a chemical stability in particular against acids and organic solvents. The substrate should possess thermal resistance of −40° C. to 300° C., preferential up to 200° C., high mechanical stability, particularly with a bend resistance of greater than 35 MPa and a modulus of elasticity of greater than 9000 Mpa.

The following describes the electrode inks and methods for production, application and post treatment of the membrane electrode unit (“MEA”).

1. Sulfonated Ionomers into Electrode Ink

Water insoluble sulfonated ionomers are dissolved in a dipolar-aprotic solvent (suitable solvents: N-methylpyrrolidinone (NMP), N,N-dimethylacetamide (DMAc), N,N-dimethylformamide (DMF), N-methylacetamide, N-methylformamide, dimethylsulfoxide (DMSO), sulfolane). Microgelparticles of the polymers are produced by controlled addition of water. The catalyst is added, along with pore builder if desired, to the formed suspension. The suspension is stirred until the suspension is as homogeneous as possible.

The total polymer percentage in suspension is 1-40% by weight, preferred are 3-30% by weight, and particular preferred are 5-25% by weight.

2. Acid Base Blends into Electrode Ink

2.a Water-Soluble Ionomers

Water-soluble cationic exchange ionomers are dissolved in the salt form SO3M, P03M2 or COOM (M=1 2, 3 or 4-valent cation, transition metal cation, Zr02+, Ti02+, metal cation or ammoniumion NR4+ (R=H and/or alkyl and/or aryl or imidazoliumion or pyrazoliumion or pyridiniumion) into water. To this solution an aqueous solution of a polymeric amine or imine (e.g., polyethyleneimine) is added, whereby the polymeric amine or imine can carry primary, secondary or tertiary amino groups or other N-basic groups. To the formed solution catalyst and, if desired, pore builder are added and the suspension is as much as possible homogenized. After applying the catalyst layer, the membrane electrode unit (MEA) is post treated in diluted aqueous acid, preferred is mineral acid, particularly phosphorous, sulfuric, nitric and hydrochloric acid. There the ionic crosslinks of the acid base blends are formed, which leads to water insolubility of the ionomer portion and to a mechanical stabilization in the electrode layer.

In a special embodiment, a heating of the membrane electrode unit also suffices. Prerequisite is that the acid-base blend is blocked by bonds which are removed by heat supply or attack of heated warm water. Examples of it are polymeric sulfonic acids which became deprotonated by urea in the cold. Counter-cations of the polymeric acid which contain titanium or zirconium cations are a further example. Heating up can be carried out also into water or steam, the temperature range between 60° C. and 150° C. is particularly preferred if water is used. In this embodiment the post treatment in acid can be discarded. Temperatures above 100° C. are realized under pressure (e.g., in an autoclave). The heating process also can be done by a microwave ray treatment under mild conditions.

The total polymer percentage in suspension is 1-40% by weight, preferred are 3-30% by weight, and particular preferred are 5-25% by weight.

The advantage of the above-mentioned method is that no anions from the acid or from the ink itself come into contact with the catalyst. The ink can be produced exclusively on a water basis.

2.b Water Insoluble Ionomers

Water insoluble cationic exchange ionomers are dissolved in the salt form SO3M, P03M2 or COOM (M=1, 2, 3 or 4-valent cation, transition metal cation, Zr02-1−, Ti02+, metal cation or ammoniumion NIR4+ (R H and/or alkyl and/or aryl or imidazoliumion or pyrazoliumion or pyridiniumion) in a suitable solvent, preferred are dipolar-aprotic solvents e.g. N methylpyrrolidinone (NMP), N,N-dimethylacetamide (DMAc), N,N-dimethylformamide (DMF), N methylacetamide, N-methylformamide, dimethylsulfoxide (DMSO), sulfolane or mixtures of these solvents with each other or mixtures of these solvents with water or alcohols (methanol, ethanol, i-propanol, npropanol, ethylenglycol, glycerine etc.). To this solution an aqueous solution of a polymeric amine or imine (e.g. polyethyleneimine) in a suitable solvent (dipolar-aprotic solvents e.g. N-methylpyrrolidinone (NMP), N,N-dimethylacetamide (DMAc), N,N-dimethylformamide (DMF), N-methylacetamide, N-methylformamide, dimethylsulfoxide (DMSO), sulfolane or mixtures of these solvents with each other or mixtures of these solvents with water or alcohols (methanol, ethanol, i-propanol, n-propanol, ethylenglycol, glycerine etc.)) is added, whereby the polymeric amine, polymer with nitrogen groups or imine can carry primary, secondary or tertiary amino groups or other N-basic groups (pyridine groups or other heteroaromatic groups or heterocyclic groups). To the formed solution catalyst and if necessary pore builder are added and the suspension is as much as possible homogenized. It has to be aimed at a water amount as high as possible if solvent-water mixtures are used. After application of the catalyst layer the MEA is post treated into acid, preferred is in diluted aqueous mineral acid. There, the ionic crosslinks of the acid base blends are formed, which leads to a stabilization of the ionomer portion in the electrode layer. Alternatively post treatment can be done as in the case of water-soluble polymers. The total polymer percentage in suspension is 1-40% by weight, preferred are 3-30% by weight, and particular preferred are 5-25% by weight.

3. Covalent Networking Concepts at the Production of Thin Layer Electrodes

Water insoluble cationic exchange ionomers are dissolved in the salt form SO3M, P03M2 or COOM (lvi=1, 2, 3 or 4 cation, transition metal cation, Zr02+, Ti02+, metal cation or ammoniumion NR4+ (R=H and/or alkyl and/or aryl or imidazoliumion or pyrazoliumion or pyridiniumion) or in its non ionic precursor SO2Y, POY2, COY (Y=Hal (F, Cl, Br, I), OR, Nfl, pyi-idinium, imidazolium) in a suitable solvent (dipolar-aprotic solvents e.g. N methylpyrrolidinone (NMP), N,N-dimethylacetamide (DMAc), N,N-dimethylformamide (DMF), N methylacetamide, N-methylformamide, dimethylsulfoxide (DMSO), sulfolane or mixtures of these solvents with each other or mixtures of these solvents with water or alcohols (methanol, ethanol, i-propanol, npropanol, ethylenglycol, glycerine etc.) or pure alcohols or mixtures of alcohols). To this solution a solution of a polymer containing crosslinking groups in suitable solvents (dipolar aprotic solvents e.g. N-methylpyrrolidinone (NMP), N,N-dimethylacetamide (DMAc), N,N dimethylformamide (DMF), N-methylacetamide, N-methylformamide, dimethylsulfoxide (DMSO), sulfolane or mixtures of these solvents with each other or mixtures of these solvents with water or alcohols (methanol, ethanol, i-propanol, n-propanol, ethylenglycol, glycerine etc.) or pure alcohols) is added, whereby the crosslinking polymer cap carry the following groups: alkene groups RC=CR2 (will be crosslinked with peroxides or with siloxanes containing Si.H groups via hydrosilylation) and/or sulfinate groups —SO2M (will be crosslinked with di or oligohalogene compounds, e.g. alpha, omega dihalogene alcanes) and/or tertiary amino groups or pyridyl groups (will be crosslinked with di- or oligohalogene compounds, e.g. alpha, omega dihalogene alcanes).

The catalyst and, if desired, pore builder are added to the formed solution and the suspension is homogenized as much as possible. It has to be aimed at a water amount as high as possible if solvent/water mixtures are used. Prior to the application of the catalyst layer, crosslinking initiators (e.g. peroxides) or crosslinker (di or oligohalogene compounds, hydrogensiloxanes etc.) are added to the suspension. The groups capable of crosslinking in the ink react with each other and with the crosslinking capable groups of the membrane. To limit the reaction of the crosslinking capable groups in the ink with itself a method is described which starts with polymeric bound alkyl halogenide groups ((halogen=iodine, bromine, chlorine or fluorine), preferred is iodine and bromine) on the membrane surface and from polymeric bound sulfinate groups in the ink. Alternatively you can start from terminal aryihalogenide groups. Fluorine as a departure group is then preferred.

These methods, particularly with alkylhalogenide, have the advantage that the addition of a crosslinker to the catalyst ink can be omitted. This makes the technical production of the MBA considerably easier in the production. The ink is applied, e.g. with a coating knife or sprayed and reacts specifically with the membrane surface.

After application of the catalyst layer the MBA is post treated in diluted aqueous mineral acid and/or water at a temperature between 0 and 150° C., preferred between 50° C. and 90° C. There the ionic crosslinks of the acid base blends are formed, which leads to a stabilization of the ionomer portion in the electrode layer.

The total polymer percentage in suspension is 1-40% by weight, preferred are 3-30% by weight, and particular preferred are 5-25% by weight.

4. Use of Non-Ionic Precursors of Cation Exchange-Ionomers

Water insoluble non-ionic precursors of a cation exchange ionomer SO2Y, POY2, COY (Y=Hal (F, Cl, Br, I), OR, NR2, pyridinium, imidazolium) are dissolved in a suitable solvent (ether solvent like tetrahydrofurane, diethylether, dioxane, oxane, glyme, diglyme, triglyme, dipolar aprotic solvent such as N-methylpyrrolidinone (NMP), N,N-dimethylacetaniide (DMAc), N,N dimethylformamide (DMF), N-methylacetamide, N-methylformamide, dimethylsulfoxide (DMSO), sulfolane or mixtures of these solvents with each other or mixtures of these solvents with water or alcohols (methanol, ethanol, i-propanol, apropanol, ethylenglycol, glycerine etc.) The catalyst and, if necessary, pore builder are added to the formed solution and the suspension is as much as possible homogenized. After application of the catalyst layer the MEA is post treated in diluted aqueous mineral acid. In doing so, the non-ionic precursors of the cation exchange groups are changed into the cation exchange groups. To dissolve the polymers basic polymers or theft precursors (amino group protected by a protection group) and/or crosslinker can be added if necessary, to increase the stability of the ionomers in the electrode layer.

The total polymer percentage in suspension is 1-40% by weight, preferred are 3-30% by weight, and particular preferred are 5-25% by weight.

5. Addition of Inorganic Nano-Particles or of its Organic Precursors to Thin Layer Electrodes

Inorganic nano-particles or their organic precursors can be added to the polymer solutions described above.

Inorganic Nano-Particles:

a) If necessary, water containing stoichiometric or non-stoichiometric oxide MxOy*n H20 (or a mixture of oxides) or hydroxide, where M represents the elements Al, Ce, Co, Cr, Mn, Nb, Ni, Ta, La, V, Ti, Zr, Sn, B and W as well as Si. All ceramic substances are present in the form of nano-crystalline powders (1-1000 nm) which have a surface of >100 m2/g. The preferred particle size amounts to 10-250 nm.

b) Stoichiometric or non-stoichiometric sparingly soluble metal phosphates or metal hydrogen phosphates or heteropolyacids of Al, Ce, Co, Cr, Mn, Nb, Ni, Ta, La, V, Ti, Zr and W, which are present in form of nano-crystalline powders.

Organic Precursors:

metal/element alkoxide/ester of Ti, Zr, Sn, Si, B, Al metalacetylacetonates, e.g. Ti(acac)4, Zr(acac)4

Mixed compounds from metal/element alkoxides and metalacetylacetonates, e.g. Ti(acac)2 (OiPr)2 etc.

organic amino compounds of Ti, Zr, Sn, Si, B, Al

The organic precursors of the metal salts or oxides or hydroxides are decomposed during the post treatment of the produced MEAs in aqueous acid and/or aqueous base or base solution, whereby the metal salts or oxides or hydroxides are released in the electrode matrix.

Main chains of the polymers used in production of electrodes
polystyrenes olystyrene, poly-A-methyl styrene, polypentafluorostyrole)
polybutadiene, polyisoprene
polyethylenimine
polybenzimidazole
polyvinylimidazole
polyvinylpyridine, polyvinylpyridiniumhalogenide
polycarbazole
polyvinylcarbazole
polyphthalazione
polyanilin
polyoxazole
polypyrrole
polythiophene
polyphenylenvinylen
polyazulen
polypyren
polyindophenine

Aryl main chain polymers containing the following construction units:

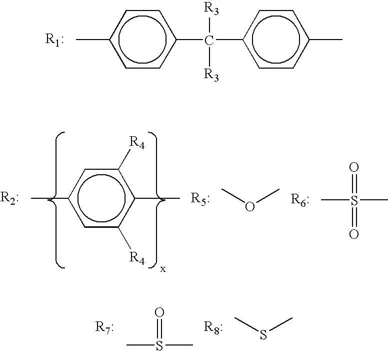

R3 stands for H, CₙH₂ₙ₊₁, with n=1-30, Hal, CₙHal₂ₙ₊₁ with n=1-30; preferred as R3 are methyl or triflouromethyl of phenyl. X can lie between 1 and 5.

These construction units can be connected with each other by the following bridge groups R4 to R8:

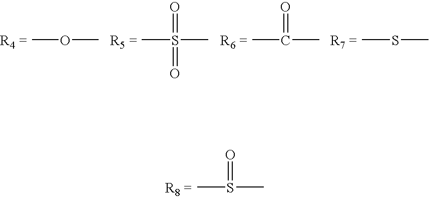

The following polymers are preferred as polymer main chains:
polyethersulfone like PSU Udel®, PBS Victrx®, PPhSU Radel R®, PEES Radel A®, Ultrason®, Victrex® HTA, Astrel®
polyphenylene like polyphenylenoxide PPO poly (2,6-dimethylphenylenether) and poly (2,6- diphenyle nether);
polyetherketone like polyetherketon PEK victrex®, polyetheretherketon PEEK Victrex®, polyetherketonetherketonketon PEKEKK Ultrapek®, polyetheretherketonketon PEEKK Hoechst, polyetherketonketon PEKK
polyphenylensulfide
methyl or triflouromethyl of phenyl.

The following paragraphs describe the development of the membrane electrode unit.

The use of the ionomer material described above opens wide variations among the transportation properties for ions, water and the reactants in the cell. Coating electrolyte membranes with a porous catalyst layer from an aqueous or solvent containing suspension is particularly promising.

The finished catalyst layer consists of the following solid constituents
20-99% by weight catalyst
0.1-80% by weight ionomer
0-50% by weight hydrophobic agent (e.g. PTFE)
0-50% by weight pore builder (e.g. (NH4) 2 C03
0-80% by weight electronic conducting phase (e.g. conducting soot or C fiber short cut) The solid content in the suspension used for the coating is 1-60% by weight.

The following methods can be used for the coating.
Spraying coating
Printing process: e.g. Silk-screen print, relief printing, gravure printing, pad printing, ink-jet pressure, stencil printing
knife coating process

The use of electrolyte material with several components permits a layerwise construction of the catalyst layer, whereby selective structures and properties of the catalyst layer can be obtained, e.g. by a layerwise construction or by use of methods which are suitable for multicolor print, can be used.

Porosity and conductivity of the layers can be influenced specifically by variation of the proportion of ion conducting phase as well as theft presence in the electrode ink (solution, suspension).

Mechanical properties, the ionic conductivity, the water retention capacity and the swelling property of the catalyst layers can be influenced by construction of gradient layers, e.g. by varying the proportion of acidic and basic polymer. By using completely water-soluble starting ionomers, the contamination of the catalyst surfaces by organic solvents is prevented. The release of inorganic nano-particles can influence the water balance positively in the catalyst layer. The use of proton conducting inorganic nano-particles permits the operation under reduced humidification.

All new ionomer structures in the electrode structure cause good power densities of the cell and decisively improve the adhesion of the electrodes (23 and 31) to the membrane (15). This is particularly important for long term performance. It turns out that good performance data of the cell are achieved particularly at low ionomer contents with the new electrode structures in comparison with the Nafion-ionomer frequently used. Best results are achieved for 1% by weight and 10% by weight while the corresponding values are 15-40% by weight for Nafion. This clarifies formation of a distinctive ionomer network which also means a lower need of costly ionomer for the production of electrodes.

The following describes a method according to the invention that binds a polymer, which is contained in an ink, covalently to a membrane. The starting point is a membrane which at least carries sulfonic acid groups at its surface. These are partly reduced preferentially at the surface to sulfinate groups in an aqueous sodium sulfite solution. The catalyst ink already contains at least a polymer, which carries sulfinate groups, in addition to the examples already described above. Short; that is less than 15 minutes from the spraying of the ink on the membrane, to the ink is added a di or oligo halogeno compound. It takes place the well known covalent crosslinking of the sulfinate carrying molecules both from the polymer molecules in the ink and between the polymers molecules of the ink and the membrane polymers, which carry crosslinkable sulfinate groups on their surface.

A variation of this method is, to react the sulfinate groups at the surface of the membrane prior to the contact with the catalyst ink with a surplus of di or oligo halogen compounds so that residues with terminal halogene groups are now on the membrane surface. On spraying the ink, now the sulfinate groups of the ink polymers will crosslink covalently (FIG. 9) exclusively with the terminal crosslinkable halogen groups of the membrane surface.

In another variation the order also can be reversed. The membrane surface carries the sulfinate groups, whereas the ink polymers carry terminal crosslink halogen groups. This method to crosslink polymers with terminal crosslinkable halogen groups and polymers with terminal sulfinate groups with each other covalently can be used also in the above specified spraying methods to the specific construction of selective and functional layers respectively. In a preferred embodiment the halogen bearing polymers and the sulfinate groups bearing polymers respectively have in addition even further functional groups on the polymer main chain.

Example for the specification: polyetheretherketonsulfonic acid chloride dissolved in NMP is knife-coated on a support e.g. a glass plate to a thin film. The solvent is removed in a drying cabinet. The film is removed from the glass plate and put into an aqueous sodium sulfite solution. The sodium sulfite solution is a saturated solution at room temperature. The membrane is taken to a temperature of 60° C. with the solution. The sulfonic acid chloride groups are reduced preferentially at the surface to sulfinate groups. Now can be further gone on several ways.

Way 1: The film with the superficial sulfinate groups is reacted with a di or oligo halogen compound, e.g. diiodinealcane, in excess in a solvent (e.g. acetone) not dissolving the membrane. The excess is a twofold excess based on halogen atoms in the alkylating reagent as compared to the sulfinate groups. The sulfinate groups react with the di iodine alcane to Polymer-SO2 Alcane iodine. The surface of the film carries terminal crosslinkable Alkyliodines. A catalyst ink is manufactured in such a way that it contains polymers with other functional groups, together with polymers which carry sulfinate groups. These react instantly at wetting with the membrane surface covalently with the terminal ailcyliodine groups. This covalent bond is the strongest bond a membrane polymer can form with an ink polymer. The formed compound is extremely stable.

Water-soluble sulfonated polymers form water insoluble complexes with polymeric amines. This is prior art. Now it has been found surprisingly, that sulfonated polymers dissolved in water can be applied with a conventional ink-jet printer defined on a surface. The limit is the point dissolving (Dot/inch) of the print cartridge. Polymeric amines with a high content of nitrogen groups, the IEC of basic groups must be over 6, especially polyvinylpyridine (P4VP) and polyethylenimin dissolve in diluted hydrochloric acid, polyethylenimine also in water. The pH value of the solution increases. This succeeds up to the neutrality. The hydrochloride of the polymeric amine, e.g. P4VP is now dissolved into water and can be applied in a surprising way very simply also over an ink-jet printer on a surface. If one uses a print cartridge now which has a chamber system for different colors, then an arbitrary mixture of a polymeric acid and a polymeric base can be printed or applied on a surface. The basic and acidic polymers react to a water insoluble tight polyelectrolyte complex. The ratio between the polymeric acid and the polymeric base can be adjusted arbitrarily over the software. Gradients of acid and basic polymers and the mixtures in each desired relationship can be manufactured in such a way. The resolution is alone dependent on the resolution of the print cartridge. With this procedure also dispersions of catalyst ink, which contain carbon particles, let themselves spray after some exercise, in combination with polymeric acids and polymeric bases. Thus micro fuel cells can be produced, which can be connected through the membrane by electron-conductive structures, optionally connected in series or parallel.

Example for the specification: The foam material cushion is removed from a print cartridge of a DeskJet (HP) and the corresponding aqueous solution of either the polymeric amine or the polymeric acid is filled in. Advantageously the container is not filled completely (half is sufficient). Graphite paper of the company Toray which has already been coated with catalyst in the spraying method is printed like normal paper now. The method can be repeated and alternated several times and an acid base blend is formed on the surface of the graphite paper.

For the direct synthesis of an acid base blend a color cartridge is filled with solutions of polymeric acid and polymeric base. In addition the third chamber (HP ink-jet cartridge) is filled with a solution containing platinum hexach. The cartridge for the “black color is used for a carbon dispersion which contains additives of low boiling alcohols used as propellant in the ink jet process, preferred are 3-7% isopropanol. Thus carbon particles which are smaller than the nozzle openings of the ink-jet cartridge can be sprayed. An almost unlimited number of possibilities of variations in the layer construction both vertically and horizontally are like this feasible. The smallest structures can be constructed purposefully.

1. Use of suitable dispersions to the layerwise construction of a galvanic cell, whereby the layers particularly are applied with only one production method and have different functional properties. Particularly advantageous production methods are spraying method, printing process (e.g. silk-screen print, relief printing, gravure printing, pad printing, ink-jet pressure, stencil printing), knife-coated processes, CYD process, lithographical method or decal picture process. The functional properties of the layers can be available alone or in an arbitrary combination and contain an ionic conductivity, electronic conductivity, mixed ionic and electronic conductivity, hydrophobic, hydrophilic, catalytic properties as well as mechanical properties like good adhesion, high tensile strength and adapted thermal extension. The layers can be made porously or thick.

2. Application of the dispersions according to claim 1 on a porous carrier substrate whose open porosity should be at least 50% in which the carrier substrate can be both electric conductive or not. A preferred embodiment contains a substrate with a surface as smooth as possible, chemical stability in particular against acids and organic solvents, thermal resistance preferred to max. 350° C., high mechanical stability, with a bend resistance of greater than 30 MPa and a modulus of elasticity of greater than 9000 MPa.

3. Formation of porous layers with the dispersions according to claim 1 by a suitable manufacturing method or addition of suitable pore builders.
